(19) United States
(12) Patent Application Publication
(10) Pub. No.: US 2025/0367862 A1
(43) Pub. Date: Dec. 4, 2025

(54) METHOD FOR FORMING PART HAVING STRUCTURAL REINFORCEMENTS

(71) Applicant: Ford Global Technologies, LLC, Dearborn, MI (US)

(72) Inventors: Patrick James Blanchard, Ann Arbor, MI (US); Scott Nydam, Farmington Hills, MI (US); Jeffrey Scott Dahl, Livonia, MI (US); Shane Michael Skop, White Lake, MI (US); Patricia Tibbenham, Armada, MI (US)

(73) Assignee: Ford Global Technologies, LLC, Dearborn, MI (US)

(21) Appl. No.: 18/679,137

(22) Filed: May 30, 2024

(51) Int. Cl. B29C 45/17; B29C 45/00; B29C 45/14; B29K 105/08; B29L 31/30

(52) U.S. Cl. CPC B29C 45/1706; B29C 45/0055; B29C 45/14631; B29C 2045/1708; B29K 2105/08; B29K 2995/0051; B29L 2031/30

(57) ABSTRACT

A method of forming a part for a vehicle. The method includes positioning a plurality of continuous fiber reinforcements within a mold cavity of a mold, filling the mold cavity including the plurality of continuous fiber reinforcements with molten resin, and injecting fluid into the mold cavity to hollow a center portion of the molten resin.

### STATEMENT REGARDING RIGHTS TO INVENTION MADE UNDER FEDERALLY-SPONSORED RESEARCH AND DEVELOPMENT

This invention was made with government support under DE-EE0009203 awarded by the U.S. Department of Energy. The government has certain rights in the invention.

### FIELD

The present disclosure relates to a method for forming a part having structural reinforcements, and more particularly, a method for forming a vehicle part having structural reinforcements.

### BACKGROUND

The statements in this section merely provide background information related to the present disclosure and does not constitute prior art.

Injection molding is a process for the manufacture of parts, for example, automotive parts. Injection molding generally involves heating a material (e.g., thermoplastic) in the form of pellets to create a molten material. This molten material flows through the injection molding equipment and is injected through one or more flow fronts to fill a mold. Once inside the mold, the molten material then cools and solidifies to form a desired part shape (which is the shape of a cavity, or multiple cavities within the mold). Polymeric/plastic materials have displaced metals as they can be formed through injection molding to form complex structures with high levels of feature integration. However, intrinsic properties of polymeric materials are typically different than intrinsic properties of metals.

### SUMMARY

This section provides a general summary of the disclosure and is not a comprehensive disclosure of its full scope or all of its features.

In one form, a method of forming a part for a vehicle is provided. The method includes positioning a plurality of continuous fiber reinforcements within a mold cavity of a mold, filling the mold cavity including the plurality of continuous fiber reinforcements with molten resin, and injecting fluid into the mold cavity to hollow a center portion of the molten resin.

In variations of the method of the above paragraph, which can be implemented individually or in any combination: removing the fluid from the mold cavity after the hollow center portion is formed; wherein the fluid is water; the plurality of continuous fiber reinforcements are unidirectional continuous fiber reinforcements; the continuous fiber reinforcements may be selected individually or in combination from the following: glass fiber, carbon fiber, metallic, and/or natural fiber, the molten resin is inserted into the mold cavity from a first side of the mold and the fluid is injected into the mold cavity from a second side of the mold that is opposite the first side; the plurality of continuous fiber reinforcements are secured within the mold cavity by retaining features; the plurality of continuous fiber reinforcements are solid, unidirectional continuous fiber reinforcements; the plurality of continuous fiber reinforcements are spaced apart from each other within the mold cavity; the method includes injection molding; and positioning a projectile within the mold cavity, wherein the fluid injected into the mold cavity moves the projectile through the mold cavity to form the hollow center portion in the molten resin.

In another form, a method of forming a part for a vehicle is provided. The method includes positioning a plurality of continuous fiber reinforcements within a mold cavity of a mold, filling the mold cavity including the plurality of continuous fiber reinforcements with molten resin, injecting water into the mold cavity to hollow a center portion of the molten resin; and removing the water from the mold cavity after the hollow center portion is formed. The continuous fiber reinforcements positioned at or near a perimeter of the mold cavity.

In variations of the method of the above paragraph, which can be implemented individually or in any combination: the plurality of continuous fiber reinforcements are unidirectional continuous fiber reinforcements; the molten resin is inserted into the mold cavity from a first side of the mold and the water is injected into the mold cavity from a second side of the mold that is opposite the first side; the plurality of continuous fiber reinforcements are secured within the mold cavity by retaining features; the plurality of continuous fiber reinforcements are solid, unidirectional continuous fiber reinforcements; the plurality of continuous fiber reinforcements are spaced apart from each other within the mold cavity; the method includes injection molding; positioning a projectile within the mold cavity, wherein the water injected into the mold cavity moves the projectile through the mold cavity to form the hollow center portion in the molten resin; and the molten resin is a polymeric material.

In yet another form, a method of forming a part for a vehicle is provided. The method includes positioning a plurality of continuous fiber reinforcements within a mold cavity of a mold, securing the plurality of continuous fiber reinforcement within the mold cavity, positioning a projectile within the mold cavity, filling the mold cavity including the plurality of continuous fiber reinforcements and the projectile with molten resin, injecting water into the mold cavity to move the projectile through the mold cavity to form a hollow center portion in the molten resin, and removing the water from the mold cavity after the hollow center portion is formed. The continuous fiber reinforcements are positioned at or near a perimeter of the mold cavity and spaced apart from each other. The plurality of continuous fiber reinforcements are unidirectional continuous fiber reinforcements.

In yet another form, a method of forming a part of a vehicle is provided. The method includes positioning at least one fiber sock within a mold cavity of a mold, filling the mold cavity including the fiber sock with molten resin, injecting fluid into the mold cavity to hollow a center portion of the molten resin, and removing the fluid from the mold cavity after the hollow center portion is formed.

In a variation of the method of the above paragraph, the fiber sock is impregnated with resin within the mold.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a perspective view of a portion of a part according to the principles of the present disclosure;

FIG. 2A is a cross-sectional view of a molding tool used to form the part of FIG. 1 according to the principles of the present disclosure;

FIG. 2B is a cross-sectional view of the molding tool of FIG. 2A used to form the part of FIG. 1;

FIGS. 3A-3F are schematic views of the molding tool of FIGS. 2A and 2B forming the part of FIG. 1;

FIG. 4 is a flowchart illustrating a method for manufacturing the part of FIG. 1 according to the principles of the present disclosure;

FIG. 5 is a cross-sectional view of another molding tool including alternate retaining features to secure fiber reinforcements therein according to the principles of the present disclosure;

FIGS. 6A-6F are schematic views of the molding tool of FIGS. 2A and 2B forming another part according to the principles of the present disclosure;

FIG. 7 is a flowchart illustrating a method for manufacturing the part of FIG. 5E according to the principles of the present disclosure;

FIGS. 8A-8F are schematic views of another molding tool forming another part according to the principles of the present disclosure; and

FIG. 9 is a flowchart illustrating a method for manufacturing the part of FIG. 8E according to the principles of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

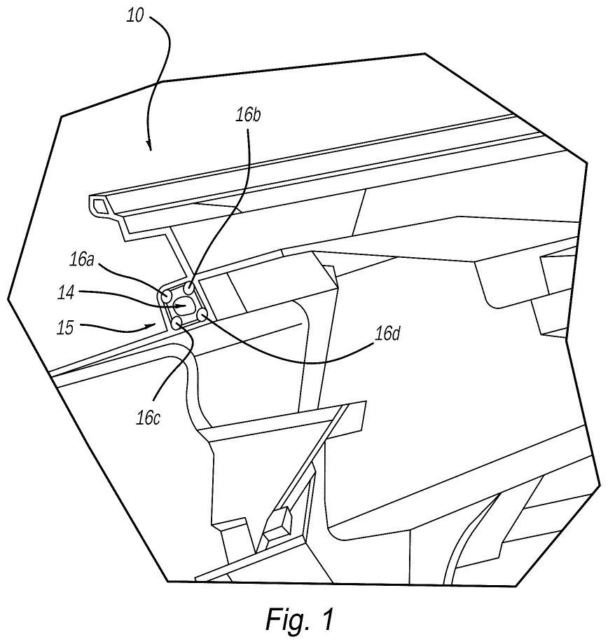

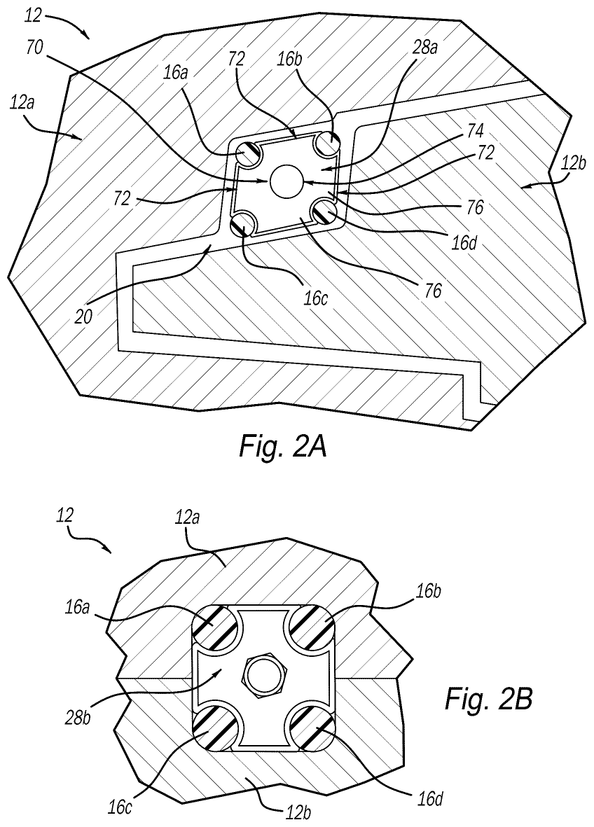

Referring to FIGS. 1, 2A, and 2B, a part 10 is illustrated in FIG. 1 and a mold or molding tool 12 for forming the part 10 is illustrated in FIGS. 2A and 2B. In one form, the part 10 may be a part of a vehicle such as a cross member to support a frunk (i.e., storage space or trunk) in a front end of an electric vehicle (not shown). In another form, the part 10 may be a tailgate reinforcement in a pick-up truck, for example. It should be understood that the part 10 may be for other exterior components or interior components of a vehicle, any reinforcement component of a vehicle, or any component where reinforcement is desirable.

In the example illustrated, the part 10 includes a predetermined portion 15 where enhanced stiffness and strength may be desired. The predetermined portion 15 includes a hollow cavity 14 and a plurality of fiber reinforcements 16a, 16b, 16c, 16d (together referred to as fiber reinforcements 16) disposed (e.g., embedded) within a resin material (e.g., polymeric material). The hollow cavity 14 is formed in the part 10 using the molding tool 12 as will be described in more detail below. In the example illustrated, the predetermined portion 15 of the part has a generally square cross-section and the fiber reinforcements 16 are located at respective corners of the predetermined portion 15 around the hollow cavity 14. For example, the fiber reinforcement 16a is located in the upper, left corner of the portion 15 of the part 10, the fiber reinforcement 16b is located in the upper, right corner of the portion 15 of the part 10, the fiber reinforcement 16c is located in the lower, left corner of the portion 15 of the part 10, and the fiber reinforcement 16d is located in the lower, right corner of the portion 15 of the part 10. In this way, the fiber reinforcements 16a, 16b, 16c, 16d are embedded within the part 10 around the hollow cavity 14, which enhances the strength and stiffness of the part 10 at the predetermined portion 15 of the part 10. In some forms, the predetermined portion 15 of the part 10 may have a circular cross-section, rectangular cross-section, or any other suitable cross-section having a hollow cavity. In such forms, the plurality of fiber reinforcements are embedded within a perimeter of the part around the hollow cavity and extend in the same direction to enhance the strength and stiffness of the part.

In one form, the fiber reinforcements 16 may be continuous fiber reinforcements where bundles called tows or tapes are oriented in the same direction (e.g., a direction extending along a length of the part 10) and woven or braided in specific patterns. The reinforcing fibers may be selected individually or in combination from the following fibers: glass fiber, carbon fiber, metallic fiber, and/or natural fiber (e.g., flax), for example. In another form, the fiber reinforcements 16 may be unidirectional, continuous fiber reinforcements where the fibers are aligned parallel in one direction for enhanced strength and stiffness in such direction. In yet another form, the fiber reinforcements 16 may be solid, unidirectional, continuous fiber reinforcements. The fiber reinforcements 16 are embedded within the part 10 during the forming process, which will be described in more detail below.

With reference to FIGS. 2A and 2B, the molding tool 12 includes a mold cavity 20 that has a shape that corresponds to a shape of a desired part. In one form, the mold tool 12 can be made of one or more parts that cooperate to define the mold cavity 20. In the example illustrated, the molding tool 12 includes first and second parts 12a, 12b that cooperate to form the mold cavity 20. A part injector 22 is associated with the molding tool 12 and is configured to inject a first fluid 34 into the mold cavity 20. In some forms, the part injector 22 may include one or more nozzles that extend through at least a portion of a wall of the molding tool 12 and into the mold cavity 20. The first fluid 34 may be a molten resin such as a single polymeric material. In some forms, the first fluid 34 may be made of different polymeric materials used to form a single molded part. A cavity injector 24 is also associated with the molding tool 12 and is configured to inject a second fluid 36 into the mold cavity 20 (i.e., into the first fluid within the mold cavity 20) to form a hollow cavity in the part. In some forms, the cavity injector 24 may include one or more nozzles that extend through at least a portion of a wall of the molding tool 12 and into the mold cavity 20. The second fluid 36 may be an inert gas, water, or oil, for example. In another form, the second fluid 36 may be a polymer material. In the example illustrated, the part injector 22 is located at one side of the molding tool 12 and the cavity injector 24 is located at another side of the molding tool 12 that is opposite the side where the part injector 22 is located. In some forms, the part injector 22 and the cavity injector 24 may be on the same side of the molding tool 12.

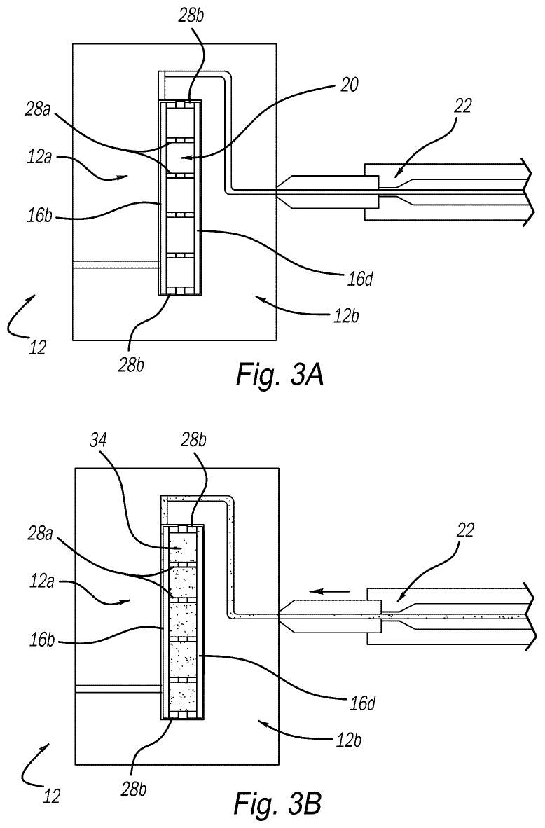

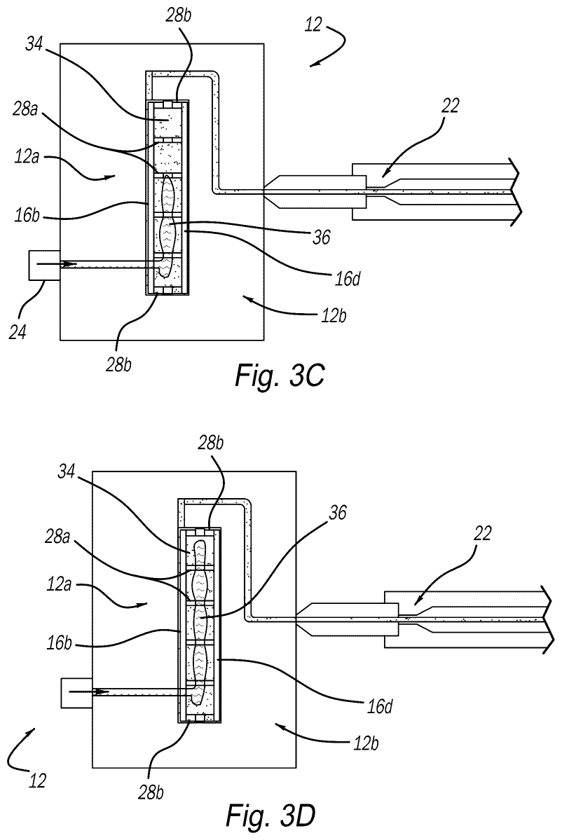

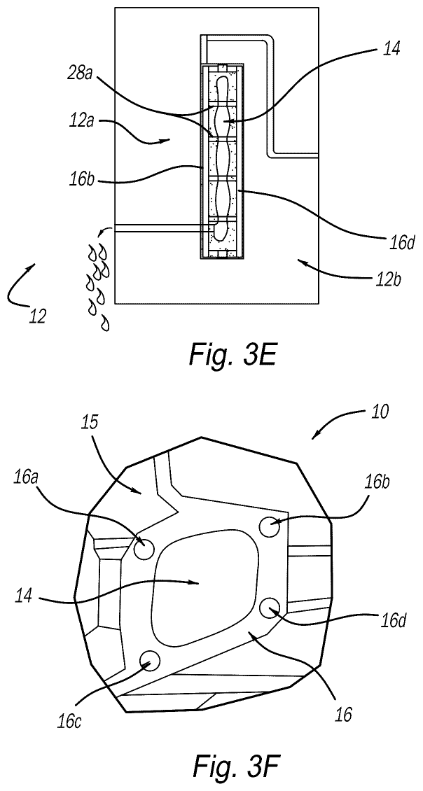

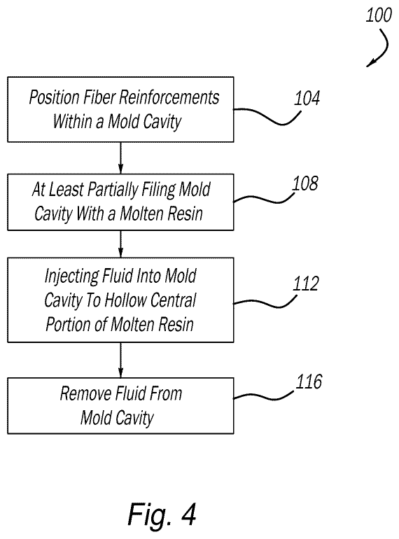

With reference to FIGS. 3A-3F and 4, a method 100 for forming the part 10 is described in detail below. At 104, the plurality of fiber reinforcements 16 are positioned within the mold cavity 20 such that the fiber reinforcements 16 extend along a longitudinal direction of the molding tool 12. That is, the molding tool 12 is open such that the mold cavity 20 is accessible and the plurality of fiber reinforcements 16 are positioned within the mold cavity 20 at or near a periphery of the molding tool 12 (only fiber reinforcements 18b, 16d shown in the FIGS. 3A-3E). The fiber reinforcement 16 are positioned within the molding tool 12 using retaining features 28a, 28b. In the example illustrated, the retaining features 28a are brackets made of metal or plastic and are spaced apart along the length of the molding tool 12. As shown in FIG. 2A, each retaining feature 28a includes a center portion 70 and gripping portions 72 extending from the center portion 70. The center portion 70 may include one or more openings 74 extending therethrough such that the first and second fluids 34, 36 may flow pass the retaining feature 28a through the mold cavity 20. Each gripping portion 72 includes a pair of arms 76 that define a space that receives a portion of a respective fiber reinforcement 16. The arms 76 may be resiliently flexible so as to allow the arms 76 to flex outward (i.e., away from each other) as the fiber reinforcements 16 are inserted within the space. When the fiber reinforcements 16 are secured to the retaining features 28a, the fiber reinforcements 28a are secured relative to each other and relative to the molding tool 12.

In one form, the retaining features 28a and the fiber reinforcements 16 are secured to each other such that the retaining features 28a are supported by the fiber reinforcements 16 (i.e., the retaining features 16 are disconnected from the molding tool 12). In another form, the retaining features 28a may include a tab (not shown) that secures the retaining features 28a to the molding tool 12, thereby further inhibiting the retaining features 28a from moving during injection of the fluids 34, 36. In yet another form, the retaining features 28a may be made of a metal material and may be urged toward one or more magnets (not shown) associated with the molding tool 12 (e.g., located outside of the mold cavity 20 or within the molding tool 12). That is, the magnets may generate a magnetic field that urges the metal retaining features 28a toward to the magnets, thus, positioning and retaining the retaining features 28a within the mold cavity 20.

With reference to FIG. 2B, the retaining features 28b may be brackets located at respective ends of the mold cavity 20 and secured to the molding tool 12 via one or more fasteners. The retaining features 28b may be made of plastic or metal. Ends of the fiber reinforcements 16 may be coupled to the retaining features 28b, thereby further inhibiting the fiber reinforcements 16 from moving within the mold cavity 20 during injection of the fluids 34, 36. The ends of the fiber reinforcements 16 may be coupled to the retaining features 28b by crimping. In another form, the ends of the fiber reinforcements 16 may be coupled to the retaining features 28b by partially wrapping the ends around the retaining features 28b in the mold cavity 20. In yet another form, the retaining features 28b may be made of a metal material and may be urged toward one or more magnets (not shown) associated with the molding tool 12 (e.g., located outside of the mold cavity 20 or within the molding tool 12). That is, the magnets may generate a magnetic field that urges the metal retaining features 28b toward to the magnets, thus, further positioning and securing the retaining features 28b within the mold cavity 20.

In yet another form, the fiber reinforcements may have metal threads that form an outer jacket around and along the fiber reinforcement. In this way, magnets located external to the mold cavity 20 may generate a magnetic field that urges the fiber reinforcements toward the magnets, thus, further positioning and securing the fiber reinforcements within the mold cavity 20. In yet another form, metal clips may be located within the mold cavity 20 and may be configured to clip onto portions of respective fiber reinforcements along a length of the fiber reinforcements. In this way, magnets located external to the mold cavity 20 may generate a magnetic field that urges the clips toward the magnets, thus, further positioning and securing the clips and fiber reinforcements within the mold cavity 20. It should also be understood that the plurality of fiber reinforcements 16 are preformed prior to being positioned or inserted into the mold cavity 20 of the molding tool 12.

With reference back to FIGS. 3A-3F and 4, at 108, the mold cavity 20 including the fiber reinforcements 16 is at least partially filled with the first fluid 34 (FIG. 3B). That is, the molding tool 12 is closed after the fiber reinforcements 16 are secured within the mold cavity 20 and the first fluid 34 is injected into the mold cavity 20 using the part injector 22. In one form, the first fluid 34 completely fills the mold cavity 20 such that the first fluid 34 completely surrounds the fiber reinforcements 16 and retaining features 28a, 28b without adjusting the molding tool 12. In another form, the first fluid 34 at least partially fills the mold cavity 20 such that the first fluid 34 completely surrounds the fiber reinforcements 16 and retaining features 28a, 28b without adjusting the molding tool 12. In the example illustrated, the part injector 22 injects the first fluid 34 into the mold cavity 20 from one end of the mold cavity 20.

At 112, the second fluid 36 (e.g., inert gas, water, oil, or a polymer) is injected into the mold cavity 20 using the cavity injector 24 to hollow a central portion of the molten resin (FIGS. 3C and 3D). That is, the second fluid 36 is injected into the mold cavity 20 such that it flows through the first fluid 34 at a predetermined portion to hollow a central portion of the first fluid 34. In this way, the first fluid 34 may be forced toward the periphery of the molding tool 12, which facilitates the formation of the hollow cavity 14 and the periphery or outer profile of the predetermined portion 15 of the part 10 once the part 10 cools and solidifies. In one form, the second fluid 36 is injected into the mold cavity 20 after the mold cavity 20 is at least partially filled with the first fluid 34.

At 116, the second fluid 36 is removed from the solid part 10. In one form, the second fluid 36 is removed from the solid part 10 by opening the cavity injector 24 (e.g., a valve associated with the cavity injector 24) and draining the second fluid 36 from the solid part 10 (FIG. 3E). The molding tool 12 is opened and the part 10 including the fiber reinforcements 16 embedded therein and surrounding the hollow cavity 14 may be removed from the molding tool 12 (FIG. 3F).

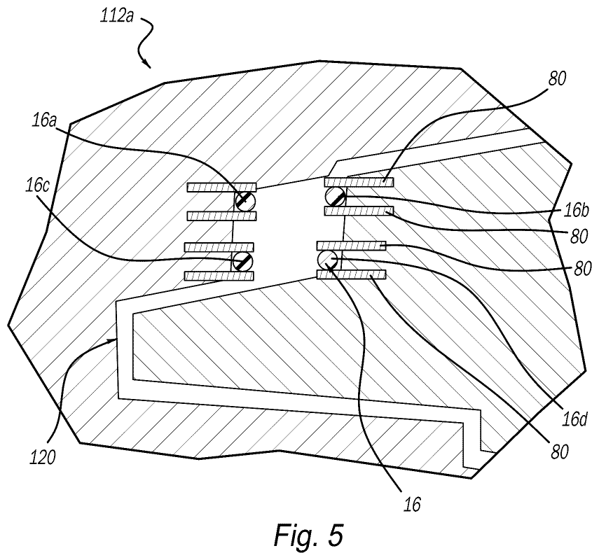

In yet another form, as shown in FIG. 5, the molding tool 112a including pairs of retractable pins 80 may be used to retain fiber reinforcements 16 therein instead of the retaining features 28a and/or retaining features 28b described above. That is, each fiber reinforcement 16 may be retained in place by a pair of retractable pins 80 associated within the molding tool 12 (i.e., each fiber reinforcement 16 is located between the pins 80) and extending into the mold cavity 120. The pins 80 may retract into the molding tool 12 once the cavity 120 is filled and additional fluid is injected into the mold cavity 20 to fill in the void or space created by the retraction of the pins 80. It should be understood that the fiber reinforcements 16 are secured in place when the pins 80 retract into the molding tool 12. In another form not shown, each fiber reinforcement is retained in place by at least one retractable pin (not shown) that extends across the mold cavity to press a respective fiber reinforcement against an internal wall defining the mold cavity as the first fluid is being injected into the mold cavity. Each pin may retract into the molding tool as the fluid fills the cavity 120 and additional fluid is injected into the mold cavity to fill in the void or space created by the retraction of the pins. It should be understood that the fiber reinforcements are secured in place when the pins retract into the molding tool.

The present disclosure provides a method for manufacturing a part 10 that includes the fiber reinforcements 16 embedded within a polymeric wall and surrounding the hollow cavity 14. In this way, the part 10 has enhanced stiffness and strength. The part 10 also has a reduced weight by the elimination of components such as steel reinforcements, for example.

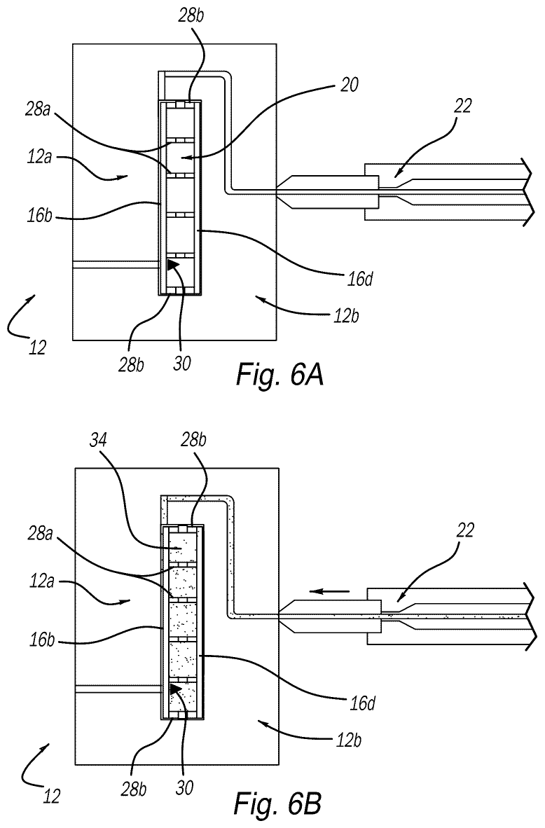

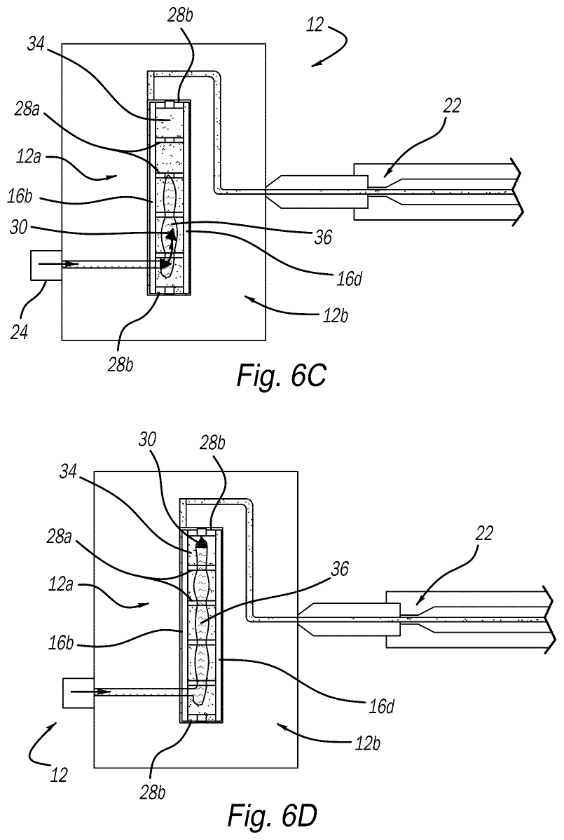

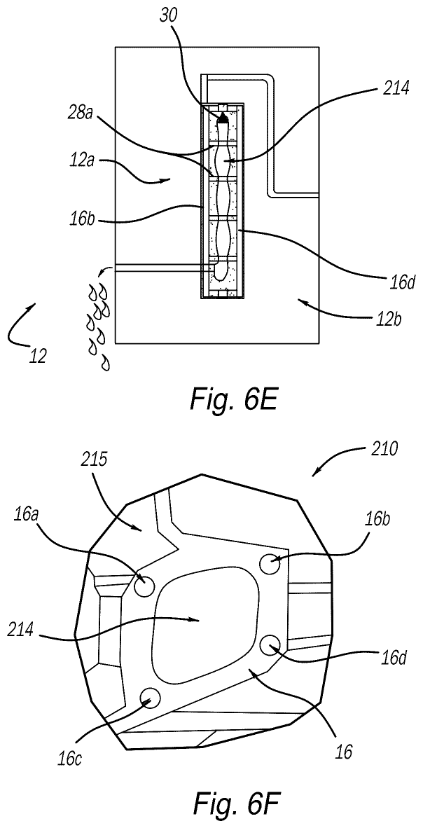

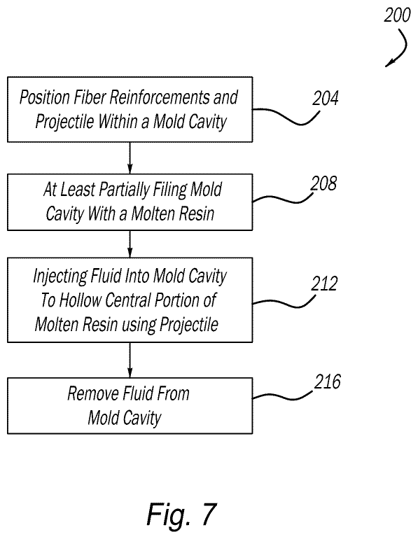

With reference to FIGS. 6A-6F and 7, another method 200 for forming part 210 is described in detail below. The method 200 may be similar or identical to the method 100 described above, apart from any exceptions noted below. At 204, the plurality of fiber reinforcements 16 and a projectile 30 are positioned within the mold cavity 20 (FIG. 6A). The fiber reinforcements 16 are positioned within the mold cavity 20 such that the fiber reinforcements 16 extend along a longitudinal direction of the molding tool 12 (only fiber reinforcements 16b, 16d are shown in the FIGS. 6A-6E). The fiber reinforcement 16 are secured to the molding tool 12 within the mold cavity 20 using retaining features 28. In the example illustrated, the projectile 30 is disposed within the mold cavity 20 at an end and may be of a solid or hollow construction. In the example illustrated, the projectile 30 has a bullet shape. In another example, the projectile 30 has any suitable shape that is allowed to move through the first fluid 34 within the mold cavity 20. It should be understood that the projectile 30 has a shape that is pre-formed prior to being disposed within the mold cavity 20.

At 208, the mold cavity 20 including the fiber reinforcements 16 and the projectile 30 is at least partially filled with the first fluid 34 (FIG. 6B). That is, the molding tool 12 is closed after the fiber reinforcements 16 and the projectile 30 are disposed within the mold cavity 20 and the first fluid 34 is injected into the mold cavity 20 using the part injector 22. In one form, the first fluid 34 completely fills the mold cavity 20 such that the first fluid 34 completely surrounds the fiber reinforcements 16 and at least partially surrounds the projectile 30. In another form, the first fluid 34 at least partially fills the mold cavity 20 such that the first fluid 34 completely surrounds the fiber reinforcements 16 and at least partially surrounds the projectile 30.

At 212, the second fluid 36 (e.g., inert gas, water, oil, or a polymer) is injected into the mold cavity 20 using the cavity injector 24 to hollow a central portion of the first fluid 34 (FIGS. 6C and 6D). That is, the second fluid 36 is injected into the mold cavity 20 such that it pushes or forces the projectile 30 through a predetermined portion of the first fluid 34 to hollow a central portion of the predetermined portion of the first fluid 34. In this way, the first fluid 34 may be forced toward the periphery of the molding tool 12, which forms the hollow cavity 214 and the periphery or outer profile of the predetermined portion 215 of the part 210 once the part 210 cools and solidifies. In the example illustrated, the second fluid 36 is injected into the mold cavity 20 such that it pushes or forces the projectile 30 from the one end of the mold cavity 20 toward another opposing end of the mold cavity 20. It should be understood that the projectile 30 is spaced apart from the fiber reinforcements 16 as the projectile 30 moves through the mold cavity 20. It should also be understood that the thickness of the walls of the polymeric part 210 is thinner than the thickness of the walls of the polymeric part 10 formed without the projectile 30. Stated differently, the projectile 30 moving through the first fluid 334 forces or pushes more of the first fluid 34 towards the periphery of the molding tool 12 compared to without the projectile 30. In this way, the thickness of the wall of the polymeric part 210 is less than the thickness of the wall of the polymeric part 10.

At 216, the second fluid 36 is removed from the solid part 210. In one form, the second fluid 36 is removed from the solid part 210 by opening the cavity injector 24 and draining the fluid from the solid part 210. The molding tool 12 is opened and the part 210 including the fiber reinforcements 16 and projectile 30 embedded therein may be removed from the molding tool 12 (FIG. 6F). The part 210 also includes a hollow cavity 214.

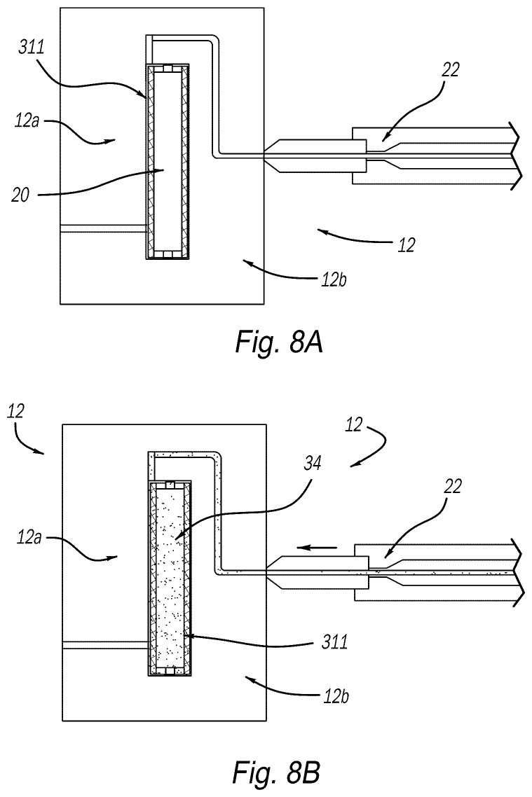

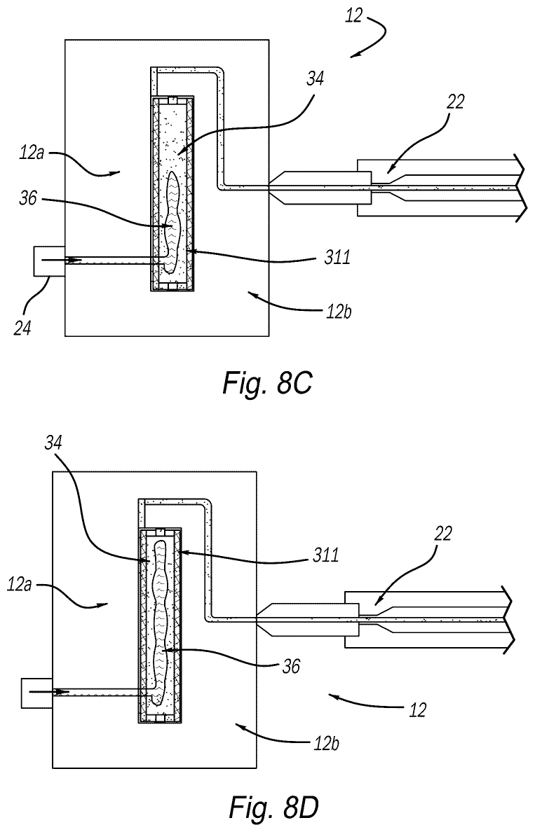

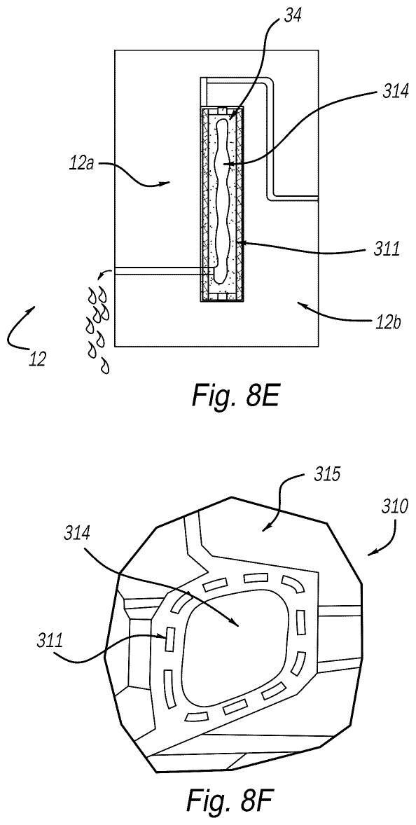

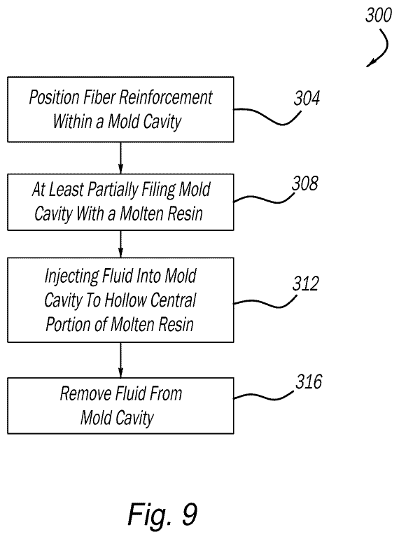

With reference to FIGS. 8A-8F and 9, another method 300 for forming part 310 is described in detail below. The method 300 may be similar or identical to the methods 100, 200 described above, apart from any exceptions noted below. At 304, the fiber reinforcement 311 is positioned within the mold cavity 20 such that the fiber reinforcement 311 extends along a longitudinal direction of the molding tool 12. The fiber reinforcement 311 may be secured to the molding tool 12 within the mold cavity 20. In some forms, the fiber reinforcement 311 may be a woven fiber sock/tube. In other forms, the fiber reinforcement 311 is a non-preformed, woven fiber sock/tube. Still, in other forms, the fiber reinforcement 311 is a mesh, non-preformed, woven fiber sock/tube.

At 308, the mold cavity 20 including the fiber reinforcement 311 is at least partially filled with the first fluid 34 (FIG. 8B). That is, the molding tool 12 is closed after the fiber reinforcement 311 is disposed within the mold cavity 20 and the first fluid 34 is injected into the mold cavity 20 using the part injector 22.

At 312, the second fluid 36 (e.g., inert gas, water, oil, or a polymer) is injected into the mold cavity 20 using the cavity injector 24 to hollow a central portion of the first fluid 34 (FIGS. 8C and 8D). That is, the second fluid 36 is injected into the mold cavity 20 such that it flows through a predetermined portion of the first fluid 34 to hollow a central portion of the first fluid 34. In this way, the first fluid 34 may be forced toward the periphery of the molding tool 12, which forms the hollow cavity 314 and the periphery or outer profile of the predetermined portion 315 of the part 310 once the part 310 cools and solidifies. The fiber reinforcement 311 is embedded within the wall of the part 310 as the part 310 cools and solidifies. In some forms, the fiber reinforcement 311 may expand toward a periphery of the mold cavity 20 as the second fluid 36 flows through the predetermined portion of the first fluid 34.

At 316, the second fluid 36 is removed from the solid part 310 (FIG. 8E). In one form, the second fluid 36 is removed from the solid part 310 by opening the cavity injector 24 and draining the second fluid 36 from the solid part 310. The molding tool 12 is opened and the part 310 including the fiber reinforcement 311 embedded therein may be removed from the molding tool 12 (FIG. 8F).

A projectile (not shown) may be positioned within the molding tool 12 in an optional step to form the hollow cavity 314. That is, the second fluid 36 (e.g., inert gas, water, oil, or a polymer) is injected into the mold cavity 20 using the cavity injector 24 such that it pushes or forces the projectile through a predetermined portion of the first fluid 34 to hollow a central portion of the first fluid 34. In this way, the first fluid 34 may be forced toward the periphery of the molding tool 12, which forms the hollow cavity 14 and the periphery or outer profile of the predetermined portion of the part 310 once the part 310 cools and solidifies.

The present disclosure provides a method for manufacturing a part 310 that includes the fiber reinforcement 311 impregnated with resin material and embedded within a polymeric wall. In this way, the part 310 has enhanced stiffness and strength. The method of the present disclosure disposes a raw fiber sock into the molding tool 12 instead of a pre-impregnated fiber sock. In this way, the impregnation of the fiber sock of the present disclosure happens inside of the molding tool 12 while the first fluid 34 is being injected into the molding cavity 20.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method of forming a part comprising:
positioning a plurality of continuous fiber reinforcements within a mold cavity of a mold;
filling the mold cavity comprising the plurality of continuous fiber reinforcements with molten resin; and
injecting fluid into the mold cavity to hollow a center portion of the molten resin.

2. The method of claim 1, further comprising removing the fluid from the mold cavity after the hollow center portion is formed.

3. The method of claim 2, wherein the fluid is water.

4. The method of claim 1, wherein the plurality of continuous fiber reinforcements are unidirectional continuous fiber reinforcements, and wherein the continuous fiber reinforcements may be selected individually or in combination from the following fibers: glass fiber, carbon fiber, metallic fiber, and/or natural fiber.

5. The method of claim 1, wherein the molten resin is inserted into the mold cavity from a first side of the mold and the fluid is injected into the mold cavity from a second side of the mold that is opposite the first side.

6. The method of claim 1, wherein the plurality of continuous fiber reinforcements are secured within the mold cavity by retaining features.

7. The method of claim 1, wherein the plurality of continuous fiber reinforcements are solid, unidirectional continuous fiber reinforcements.

8. The method of claim 1, wherein the plurality of continuous fiber reinforcements are spaced apart from each other within the mold cavity.

9. The method of claim 1, wherein the method comprises injection molding.

10. The method of claim 1, further comprising:
positioning a projectile within the mold cavity,
wherein the fluid injected into the mold cavity moves the projectile through the mold cavity to form the hollow center portion in the molten resin.

11. A method of forming a part comprising:
positioning a plurality of continuous fiber reinforcements within a mold cavity of a mold, the continuous fiber reinforcements positioned at or near a perimeter of the mold cavity;
filling the mold cavity comprising the plurality of continuous fiber reinforcements with molten resin;
injecting water into the mold cavity to hollow a center portion of the molten resin; and
removing the water from the mold cavity after the hollow center portion is formed.

12. The method of claim 11, wherein the plurality of continuous fiber reinforcements are unidirectional continuous fiber reinforcements, and wherein the reinforcing fibers may be selected individually or in combination from the following fibers:
glass fiber, carbon fiber, metallic, and/or natural fiber.

13. The method of claim 11, wherein the molten resin is inserted into the mold cavity from a first side of the mold and the water is injected into the mold cavity from a second side of the mold that is opposite the first side.

14. The method of claim 11, wherein the plurality of continuous fiber reinforcements are secured within the mold cavity by retaining features.

15. The method of claim 11, wherein the plurality of continuous fiber reinforcements are solid, unidirectional continuous fiber reinforcements.

16. The method of claim 11, wherein the plurality of continuous fiber reinforcements are spaced apart from each other within the mold cavity.

17. The method of claim 11, further comprising:
positioning a projectile within the mold cavity,
wherein the water injected into the mold cavity moves the projectile through the mold cavity to form the hollow center portion in the molten resin.

18. A method of forming a part comprising:
positioning at least one fiber sock within a mold cavity of a mold;
filling the mold cavity comprising the at least one fiber sock with molten resin;
injecting fluid into the mold cavity to hollow a center portion of the molten resin; and
removing the fluid from the mold cavity after the hollow center portion is formed.

19. The method of claim 18, wherein the at least one fiber sock is impregnated with resin within the mold.

20. The method of claim 18, further comprising positioning a projectile within the mold cavity, wherein the fluid injected into the mold cavity moves the projectile through the mold cavity to form the hollow center portion in the molten resin.
